(19) United States
(12) Patent Application Publication
(10) Pub. No.: US 2009/0254865 A1
(43) Pub. Date: Oct. 8, 2009

(54) GRAPHICAL USER INTERFACE FOR ACCESSING INFORMATION ORGANIZED BY CONCENTRIC CLOSED PATHS

(75) Inventor: Richard J. Siegel, Katonah, NY (US)

Correspondence Address: DICKSTEIN SHAPIRO LLP, 1633 Broadway, NEW YORK, NY, 10019, US

(73) Assignee: Arch Bridge Holdings, Inc.

(21) Appl. No.: 12/099,008

(22) Filed: Apr. 7, 2008

(51) Int. Cl. G06F 3/048

(52) U.S. Cl. 715/835

(57) ABSTRACT

A graphical user interface for a computer system having a plurality of icons, each icon representing an activity. A display controller launches the activity associated with a selected icon when selected. An organization algorithm directs a processor of the computer system to arrange the plurality of icons along a sequence of consecutive closed paths, each closed path representing an organizational level of associated activities.

### FIELD OF THE INVENTION

The present invention relates generally to user interfaces for computer systems and hand-held devices, and particularly to an arrangement for organizing and augmenting information in a user interface by concentric closed paths.

### BACKGROUND OF THE INVENTION

Web pages have become an essential part of our lives. The World-Wide Web (“Web”) was initially designed for browsing Web content with personal computers having screens capable of fitting the content of most Web pages. As Web pages contain an ever increasing amount of content, conventional Web browsing techniques and user interfaces are unable to efficiently organize and convey the content in a manner consistently useful to its users.

In addition to the organizational deficiencies associated with the display of large amounts of Web content on a limited screen, with the expansion of wireless Internet, hand-held devices such as small-screen PDAs and cell phones are gaining popularity in Web browsing applications. Since the design and layout of Web pages do not always fit within the limited screen dimensions of hand-held display devices, browsing with these devices usually involves a significant amount of horizontal and vertical scrolling. The limited screen size of hand-held devices also makes efficiently organizing and conveying Web content difficult. Furthermore, small displays offer narrow interaction bandwidths making it cumbersome and tedious to get to the pertinent content in a page. These setbacks are further exacerbated when Web browsing involves a number of steps spanning several pages as with online transactions, e.g., shopping, registrations, bill payments, banking, investing, etc. Web browsing with the above described limitations becomes time-consuming, strenuous, and causes significant information overload. The same deficiencies are true for many other computer-based applications. In particular, the loss of spatially organized content and the confusion associated with viewing such content makes it difficult for users to efficiently comprehend, organize and analyze the electronic information conveyed. While content summarization techniques aimed at summarizing or reducing the complexity of Web content can somewhat compensate for this loss, it alone is inadequate for alleviating the information overload experienced by the users. Such techniques diminish the value of pertinent content or, even worse, result in the loss of such content.

The above concerns particularly affect the modern day money manager. In a money management environment a significant amount of Web content from multiple online sources needs to be presented to investment professionals in a concise and well-organized manner so that fully informed fund management decisions can be made without information overload.

Users need to be able to efficiently, quickly and effectively distinguish more relevant Web content from less relevant Web content. For example, in the hedge fund context, hedge fund managers routinely rely on the internet when researching and analyzing investment opportunities. Using a tab based menu at the top of the screen to navigate between categories of Web content facilitates this end. However, a tab-based user interface remains inconvenient if there are more tabs than will fit on the screen at once. Further approaches, such as adding additional user interface elements (such as scroll arrows) to scroll the tabs left and right in order to view all of the tabs leave too large a footprint on the display screen, obscuring information from being displayed. These approaches require additional graphical user interface (GUI) elements, which can be problematic when using small screens. Additionally, these elements are often small, and therefore harder to activate (by stylus, mouse or touch screen).

Thus, there is a need for developing techniques to improve the user experience of both computer and mobile hand-held users to better organize information and reduce information overload in Web browsing.

### SUMMARY OF THE INVENTION

The present invention uniquely arranges and presents electronic Web content to users through a GUI. A user interface in accordance with the present invention groups Web content into a plurality of icons along a sequence of concentric closed paths, each closed path representing an organizational level of electronic information associated with each icon. The icons are displayed on a display screen wherein each icon is adapted to be selected by a user and is operable to display the associated electronic information. In response to the selection of a first icon, the electronic information associated with the first icon is displayed on the screen.

In one aspect, the present invention is directed to a system comprising a plurality of icons, where each icon may represent an activity, a display controller, a processor or an organization algorithm. The display controller launches the information associated with a selected icon when selected and the organization algorithm directs the processor to arrange the plurality of icons along a sequence of consecutive closed paths, each closed path representing an organizational level of information.

In another aspect, the display controller is a touch responsive display.

In another aspect, the activity is rendering electronic information.

In another aspect, the activity is execution of a program by the processor.

In another aspect, the present invention is directed to a system for presenting icons on a graphical user interface, comprising: a computer having a memory and a processor; and a computer-readable medium for generating software code, which, when said code is loaded into the memory and run by the processor, causes the processor to perform the steps of: arranging a plurality of icons along a sequence of concentric closed paths, each closed path representing an organizational level of electronic information associated with each icon; displaying the plurality of icons on a display screen, wherein each icon is adapted to be selected by a user and is operable to launch an associated activity; and in response to the selection of a first icon, displaying the electronic information on the screen.

In another aspect, a first icon is selected by contact with said touch responsive display.

In another aspect, the sequence of concentric closed paths comprise at least two concentric rectangular arrays of icons surrounding a center display portion, said center display portion configured to display one or more icons.

In another aspect, the concentric rectangular arrays are arranged in a matrix.

In another aspect, the matrix comprises 6 rows and 7 columns.

In another aspect, the electronic information comprises a Website.

In another aspect, the activity comprises executing a software application stored in the memory.

In another aspect, the present invention is directed to a method for presenting icons on a graphical user interface comprising: arranging a plurality of icons along a sequence of concentric closed paths, each closed path representing an organizational level of electronic information associated with each icon; displaying the plurality of icons on the screen, wherein each icon is adapted to be selected by a user and is operable to display the associated electronic information; and in response to the selection of a first icon, displaying the electronic information on a display screen.

In another aspect, an innermost one of the concentric closed paths comprises electronic information of a first organizational level, and wherein a second one of the concentric closed paths comprises electronic information of a different organizational level.

In another aspect, the second one of the concentric closed paths is disposed generally outside the innermost one of the concentric closed paths.

In another aspect, the sequence of concentric closed paths comprise at least two concentric rectangular arrays of icons surrounding a center display portion, said center display portion configured to display one or more icons.

In another aspect, the sequence of concentric closed paths comprise at least two concentric rectangular arrays of icons surrounding a center display portion, said center display portion configured to display the electronic information associated with a selected icon.

These and further features and advantages of the present invention will become more apparent from the following description when taken in connection with the accompanying drawings which show, for purposes of illustration only, several embodiments in accordance with the present invention.

### BRIEF DESCRIPTION OF THE DRAWINGS

FIG. 1 is an architectural block diagram for a system embodiment of the present invention;

FIG. 2 is an exemplary screen layout of a user interface;

FIG. 3 is a flow chart outlining steps performed for presenting icons on a graphical user interface in accordance with an embodiment of the present invention; and

FIG. 4 illustrates examples of computer readable media.

### DETAILED DESCRIPTION OF PREFERRED EMBODIMENTS OF THE INVENTION

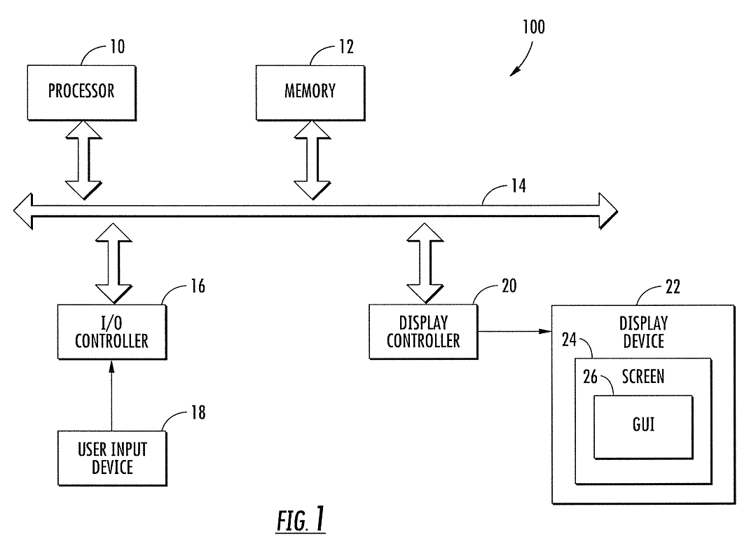

FIGS. 1-4, discussed below, and the embodiment used to describe the principles of the present invention are by way of illustration only and should not be construed in any way to limit the scope of the invention. Well-known components have been shown in block diagram form in order not to obscure the present invention in unnecessary detail. Certain details regarding graphical user interfaces described herein have been omitted insomuch as such details are not necessary to obtain a complete understanding of the present invention and are within the skill of a person of ordinary skill in the relevant art.

Web content can be displayed in a vast array of styles and layouts. Web content presented by Web browsers can range from highly relevant content of most significance to a user (e.g., market rates to an investor, account data to sales representative, etc.) to content of little relevance (e.g., marketing advertisement and promotional materials). By way of overview, the present invention exploits the wide range of Web content configured for display by a GUI and presents this content in an organized, user-friendly fashion, by grouping Web content in organizational levels based on one or more characteristics of the content, such as relevance, level of importance to the user, sensitiveness of the content to change, permission levels associated with the content, etc.

In accordance with an embodiment of the present invention, content is analyzed and then grouped into levels according to an organizational strategy. The organizational strategy can be any method of grouping content on a user interface and preferably has a methodology for classifying the content in accordance with one or more characteristics of the content. Content in the same organizational level is arranged within a closed path and the closed path of one level surrounds, or is surrounded by, the closed path of another level. This organizational arrangement, whereby content of different organizational levels is arranged in closed paths, are described herein with reference to concentric closed paths. A closed path is defined as any path which encompasses one or more icons thereby defining an organizational level with respect to the surrounded icon(s), wherein the electronic information associated with each icon shares a characteristic common to that level. Each closed path is concentric with each other closed path, such that each closed path surrounds closed paths of lower levels.

The present invention may be described herein in terms of functional block components, code listings, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as Basic, C, C++, C#, Java, HTML, COBOL, assembler, PERL, or the like, with the various algorithms being implemented with any combination of data structures, objects, processes, routines or other programming elements. The computer code is preferably programmed in C++. The object code can preferably be executed by any computer having a Windows 98 or higher or MAC O.S. 9 or higher operating system.

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

### System Architecture

The present invention is for use with display screens and monitors, such as those used in conjunction with computing devices, PDAs, cell phones, and other handheld mobile devices. Referring to FIG. 1, system 100 includes a processor 10, memory 12, system bus 14, I/O controller 16, user input device 18, display controller 20 and display device 22. Processor 10 and memory 12 are interconnected by system bus 14 which includes control signals as well as address lines and data lines for sharing information, including data and instructions, between the components of system 100. Also connected to system bus 14 is I/O controller 16 which controls signals received from user input device 18 and provides those signals, which indicate instructions from the user, to processor 10. User input device 18 can include a keyboard, mouse, touchpad, trackball, pen input mechanism, or any other device capable of receiving user input. Any device capable of indicating and selecting x-y coordinates on display device 22 may be utilized as user input device 18. In accordance with a preferred embodiment of the present invention, user input device 18 is a touch screen which can detect the location of touches within the display area 24 of display device 22. This allows display device 22 to be used as an input device, removing the keyboard and/or the mouse as the primary input device for interacting with the display's content.

Display controller 20 is coupled to the system bus 14 and receives commands and data from processor 10 and from memory 12 via system bus 14. Display controller 20 controls display device 22 which provides images on display screen 24. Display device 22 may be any one of a variety of known display devices found on computer monitors, PDAs, cell phones and other hand held computing devices. One example of display device 22 is a liquid crystal display.

Display device 22 is shown displaying a GUI 26 on screen 24. User input device 18 provides user control of GUI 26 allowing the user to point to an item on display screen 24 and perform an operation on that item using processor 10, such as signaling to system 100 that the item has been selected for an operation or that a particular command has been selected by the user. Since the operation of pointing to an item and selecting the item using touch screens is well known in the art further discussion on the use of touch screens has been omitted.

### Interface Layout

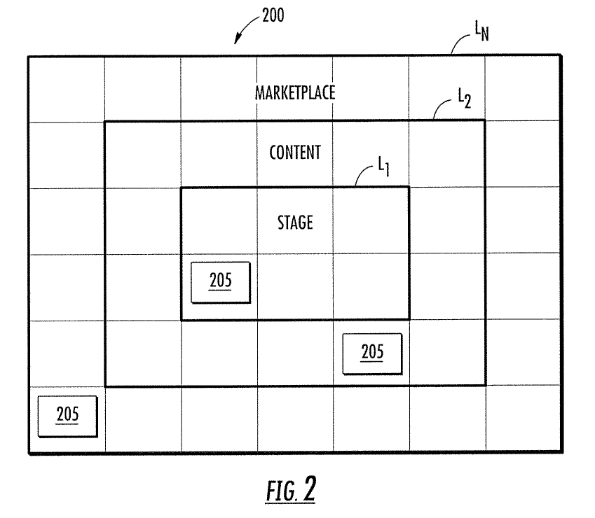

FIG. 2 is a screen shot of GUI 200 and includes a plurality of on-screen icons 205. GUI 200 is configured for display on screen 24 of display device 22. Icons 205 are arranged within concentric closed paths identified as levels L₁-L_{N}. Each level L₁-L_{N} represents an arrangement of icons having some character or trait in common. Icons 205 are user selectable. In response to a user's selection of icon 205 the content associated with the icon can be displayed on screen 24 or further action with respect to the selected icon can be commenced.

### Icons

Icons 205 represent information to be rendered. Icons 205 can represent many objects useful to users. For example, icons 205 can include Web content, control functions, electronic forms or documents, electronic media, and computer programs, etc. Icons 205 may preferably represent any content, or combination of content, accessible over the Web. In accordance with a preferred embodiment, icons 205 represent electronic information useful for assisting hedge find professionals in making hedge fund decisions. When an activity is associated with or assigned to an icon 205, selection of the icon by user input device 18 results in execution of the activity by processor 10. Icons 205 can be static (time invariant) or dynamic, indicating the current status of the information that is represented. Accordingly, hedge fund professionals can be provided with well-organized, up-to-the-minute information on potential investments.

### Arrangement of the Icons

As mentioned above, icons 205 are arranged within concentric closed paths, each closed path encompassing an organizational level L₁-L_{N} of information. In accordance with an embodiment of the present invention, levels L₁-L_{N} and icons 205 contained therein are formed from a matrix having a certain number of rows and columns. FIG. 2 illustrates a matrix with 7 columns and 6 rows. However, the present invention is not so limited and those of skill in the art will appreciate that the disclosed matrix can have any number of columns and rows and the invention can be practiced with any number of levels L_{N}.

Content is analyzed and then grouped into levels according to an organizational strategy. The organizational strategy can be any method of grouping content on a user interface and preferably has a methodology for classifying the content in accordance with one more characteristics of the content. Referring to FIG. 2, content in the same organizational level can be surrounded by a closed path and the closed path of each level surrounds, or is surrounded by, the closed path of another level. A closed path is defined as any path which encompasses one or more icons thereby defining an organizational level with respect to the surrounded icon(s), wherein the electronic information associated with each icon within the surrounded path shares a characteristic common to that level. Each closed path is concentric with each other closed path, such that each closed path surrounds the closed paths of lower levels.

The concentric closed paths discussed above are shown in FIG. 2 as continuous rectangular arrays of icons. The closed path of level L₂ is outside the closed path of level L₁ and inside the closed path of level L_{N}. In other words, level L₂ encompasses the rectangular array of level L₁ and the rectangular array of level L_{N} encompasses the rectangular array of level L_{N-1} (levels L₃ through L_{N-1} not shown). Level L₁ is at the center of GUI 200.

Icons 205 need not be arranged in arrays of rectangles and can be arranged in any manner capable of differentiating between distinct levels of icons. More generally, icons 205 can be arranged in arrays surrounded by concentric polygons or closed paths. For example, in accordance with alternative arrangements of the present invention, icons 205 can be arranged in an array of concentric circles, triangles, or even a rendering closed loop or path.

While the innermost level L₁ is indicated in FIG. 2 as comprising six icons 205, the present invention is not so limited. Each closed path can surround as many, or as few, icons 205 as desired as long as each closed path is concentric with each other closed path and the icons in each closed path have some characteristic with each other. In accordance with a preferred arrangement of icons, the most relevant electronic information is presented at the center of GUI 200 within level L₁. When GUI 200 is expanded to fit the dimensions of a display screen, the user's eye will naturally focus on the center of the screen and, hence, the center of GUI 200. This is where the most relevant electronic information should be displayed. In accordance with alternative arrangements, level L₁ can be used to display the least important electronic information and the outermost level L_{N} can be used to display the most important electronic information. Accordingly, the importance of arranging electronic information in icons within the confines of different levels depends on the business use, purpose etc. Thus, while hedge fund professionals may desire to have the most important electronic information in the center of GUI 200 (level L₁), other users may desire to have this information within another level, outside of level L₁.

Icons 205 within one concentric closed path can overlap with icons 205 of another closed path. For example, one or more icons 205 of level L₂ can be configured to overlap the icons of other levels when selected by a user. This could be of particular importance when displaying the content of a user selected icon 205. A user selected icon 205, or the level the selected icon 205 belongs to, can be enlarged, temporarily overlapping surrounding levels. The overlapped levels, or all levels not associated with the selected icon 205, can be temporarily grayed out to highlight and/or bring the selected icon 205 and its associated level to the attention of the user. Levels L₁-L_{N} can be further differentiated by color, shape, size, etc. For example, level L₂ icons can be of a different size than level L₁ icons and vice versa. This of particular importance because a larger level can display more icons and electronic information. Should it be necessary for level L₂ to contain more electronic information than its surrounding levels, level L₂ can be made larger to accommodate this content.

In accordance with further arrangements of the present invention, GUI 200 can include a selection means, such as a menu, tab or prompt, for allowing users to choose the content of levels L₁-L_{N}. Accordingly, a user can select how icons 205 will be arranged into levels.

Icons 205 are configured for display on screen 24 of display device 22 and each icon 205 is user selectable and operable to display and/or execute the information content associated with the selected icon.

### Displaying Electronic Information

Display controller 20 makes possible the display and/or execution of content associated with a selected icon when selected by user input device 18. In accordance with a preferred embodiment, user input device 18 is a touch responsive display and a icon 205 can be selected by contact with the touch responsive display.

In response to the selection of an icon 205 by user input device 18, display controller displays content associated with the selected icon 205 on the display screen 24. In accordance with an embodiment of the present invention, content associated with a selected icon 205 can be displayed in the area encompassed by the rectangular array of level L₁. Since L₁ is at the center of GUI 26 it is in a position where the user's eye naturally tends to focus when observing display screen 24. Accordingly, the selected content is displayed in the center of the screen where it can be most easily absorbed by the user. It should be apparent to those of skill in the art that the display of information in an area encompassed by L₁ may temporarily overlay, obscure or replace the icons currently in L₁. The selected information will continue to be displayed until the user selects another icon 205. Selection of a subsequent icon 205 will cause display controller 20 to remove the previously selected content from L1 in favor of the newly selected content.

### Organizational Algorithm and Method

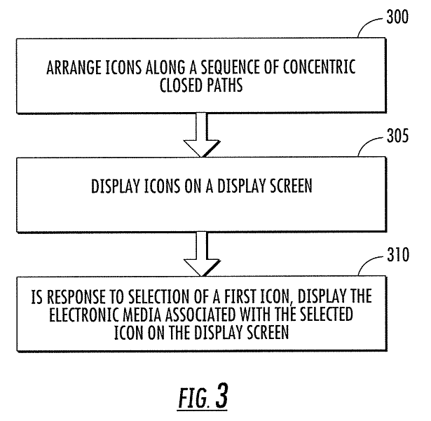

Processor 10 includes an organizational algorithm for arranging the plurality of icons 205 among levels L1-L3. Referring to FIG. 3, a method for presenting icons on GUI 26 begins at step 300 by arranging icons 205 along a sequence of concentric closed paths, each closed path representing an organizational level L1-L3 of electronic information associated with each icon 205. Next, in step 305, the icons 205 are displayed on screen 24. As discussed above, each icon 205 is adapted to be selected by a user and is operable to display the associated electronic information. Lastly, in step 310, electronic information is displayed on display screen 24 in response to user selection of an icon 205.

### Software on Media

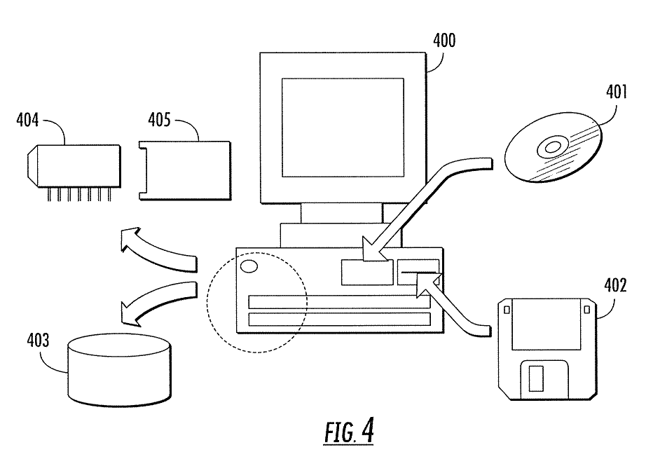

In the specification, the term “media” means any medium that can record data therein. FIG. 4 illustrates examples of recording media.

The term “media” includes, for instance, a disk shaped media 401 such as CD-ROM (compact disc-read only memory), magneto optical disc or MO, digital video disc-read only memory or DVD-ROM, digital video disc-random access memory or DVD-RAM, a floppy disc 402, a memory chip 404 such as random access memory or RAM, read only memory or ROM, erasable programmable read only memory or E-PROM, electrical erasable programmable read only memory or EE-PROM, a rewriteable card-type read only memory 405 such as a smart card, a magnetic tape, a hard disc 403, and any other suitable means for storing a program therein.

A recording media storing a program for accomplishing the above mentioned apparatus may be accomplished by programming functions of the above mentioned apparatuses with a programming language readable by a computer 400 or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer processing device 400, any suitable device for performing computations in accordance with a computer program may be used. Examples of such devices include a personal computer, a laptop computer, a microprocessor, a programmable logic device, or an application specific integrated circuit.

### Three-Dimensional Embodiment

The present invention has been described as operating on a two-dimensional graphical user interface. However, the present invention is not so limited and can be applied to a three-dimensional user interface projected on a two-dimensional screen. Alternatively, it is contemplated that the user interface may be rendered in a three-dimensional virtual reality environment including, for example, a glove selector. For three-dimensional applications closed paths are implemented as closed surfaces or shells in three-dimensional space, and the remaining expedients detailed above can be applied with respect to the shells.

### Exemplary System Operation

In accordance with one embodiment of the present invention, a graphical user interface matrix and communications hub is configured to access and augment information organized by concentric closed paths in a digital superfast broadband Internet. The graphical user interface matrix has universal utility that offers the principal investment decision-maker in a hedge fund or money management context an efficient platform or screen for timely weighing both sides of an investment decision. The matrix is programmable to highlight both sides of an investment idea in a balanced debate format illustrative of a level playing field that accommodates rapid visual and mental processing. In one embodiment, half of the modular space of a 42-icon matrix arranged 7 across and 6 down, that is, 21 of the modules, could be reserved for the ‘long’ or bullish opinions of the analysts covering a company or some industry sector. The other half of the modular space, consisting in this scenario of the other 21 of the 42-icon matrix, would be dedicated to the other side of the debate, that is, the ‘short’ or bearish opinions of the same investment idea or trend. In this descriptive embodiment, the decision-maker would have access to all of the relevant information he or she needs to assess a situation with lightning speed, where the icons provide accessibility to information within a digital superfast broadband environment. The decision-maker would have an efficient debate format for making a fast, but methodical investment decision.

The graphical user interface delivers information of various formats to users in a high speed environment. In accordance with one embodiment, the area of the graphical user interface is comprised of 42, 100×100 pixel squares in a 7×6 matrix. It has three distinct levels, defined as a marketplace, content and stage, respectively, with corresponding closed paths that organize the icons therein.

The outermost closed path contains the marketplace, which is utilized for advertising, via sponsorship or on a click-through basis. Marketplace icons will open a new browser window or tab on the user's machine to view the linked content. In accordance with alternative embodiments of the present invention, the outermost closed path can also contain news or content-rich material.

The icons generate different views within the stage when clicked by the user. A change in representation of the icon currently activated is visually indicated in addition to the change in display on the stage. When an icon is selected, the user interface transitions to the new stage content in a variety of ways depending on its type.

The innermost closed path contains the stage. The stage is a versatile display for multiple mediums of information. The stage is tied to the icons as a control for displaying the content of selected icons and for creating unique page views. Transitions from different content will be handled individually depending on the media type. For image content, the transition can fade the current image and replace it with a new one, or slide the image back to its tab as the new one forms. Video content can load a flash video within the stage area for viewing with playback controls at the bottom. Text content can appear with a scrollable control or magnifier to aid viewing depending on its length. Media content can fill its entire area, or it can be broken down into the 100×100 squares and manipulated. An example of this is displaying a picture slideshow with 6 rotating images on the stage that can individually be expanded within the stage.

One skilled in the art will appreciate that additional variations may be made in the above-described embodiment of the present invention without departing from the spirit and scope of the invention which is defined by the claims which follow.

What is claimed is:

1. A method for presenting icons on a graphical user interface comprising:
arranging a plurality of icons in concentric closed paths, each closed path surrounding an organizational level of icons;
displaying the plurality of icons on the screen, wherein each icon is adapted to be selected by a user and is operable to display electronic information; and
in response to the selection of a first icon, displaying electronic information associated with the first icon on a display screen.

2. The method of claim 1 wherein a first closed path surrounds icons of a first organizational level, and wherein a second closed path surrounds icons of a different organizational level from the first organizational level.

3. The method of claim 2 wherein the second closed path is outside the first closed path.

4. The method of claim 2, wherein the first and second closed paths surround a rectangular array of icons.

5. The method of claim 2, wherein the first and second closed paths surround a rectangular array of icons and a center display portion, said center display portion configured to display the electronic information associated with a selected icon.

6. The method of claim 4 wherein the rectangular array of icons are arranged in a matrix.

7. The method of claim 6 wherein the matrix comprises 6 rows and 7 columns.

8. The method of claim 6 wherein the display screen is a touch responsive display.

9. The method of claim 8 wherein a first icon is selected by contact with said touch responsive display.

10. A graphical user interface for a computer system, the system comprising:
a plurality of icons, each icon representing an activity;
a display controller;
a processor; and
an organization algorithm;
wherein the display controller launches the activity associated with a selected icon when selected; and
wherein the organization algorithm directs the processor to arrange the plurality of icons in consecutive closed paths, each closed path representing an organizational level of icons.

11. The system of claim 10 wherein the display controller is a touch responsive display.

12. The system of claim 10 wherein the activity is rendering electronic information.

13. The system of claim 10 wherein the activity is execution of a program by the processor.

14. A system for presenting icons on a graphical user interface, comprising:
a computer having a memory and a processor; and
a computer-readable medium for generating software code, which, when said code is loaded into the memory and run by the processor, causes the processor to perform the steps of:
arranging a plurality of icons in concentric closed paths, each closed path representing an organizational level icons;
displaying the plurality of icons on a display screen, wherein each icon is associated with electronic information and is adapted to be selected by a user; and
in response to the selection of a first icon, displaying the electronic information associated with the first icon on the screen.

15. The system of claim 14 wherein the activity is rendering electronic information.

16. The system of claim 14 wherein the display screen comprises a touch responsive display.

17. The system of claim 16 wherein a first icon is selected by contact with said touch responsive display.

18. The system of claim 14, wherein the concentric closed paths comprise at least two concentric rectangular arrays of icons.

19. The method of claim 18 wherein the concentric rectangular arrays are arranged in a matrix.

20. The method of claim 19 wherein the matrix comprises 6 rows and 7 columns.

21. The system of claim 14, wherein the system comprises a handheld computing device with wireless networking capabilities.

22. The system of claim 14, wherein the electronic information comprises a Website.

23. The system of claim 14, wherein the activity comprises executing a software application stored in the memory.
